(19) United States
(12) Patent Application Publication
(10) Pub. No.: US 2011/0235805 A1
(43) Pub. Date: Sep. 29, 2011

(54) STORAGE SYSTEM AND METHOD FOR GENERATING ENCRYPTION KEY IN THE STORAGE SYSTEM

(75) Inventors: Shimpei Usui, Yokohama (JP); Akinobu Watanabe, Kawasaki (JP); Toshihiro Kato, Tokyo (JP)

(73) Assignees: Hitachi-LG Data Storage, Inc.; Hitachi Consumer Electronics Co., Ltd.

(21) Appl. No.: 12/956,269

(22) Filed: Nov. 30, 2010

(30) Foreign Application Priority Data
Mar. 23, 2010 (JP) 2010-066365

(51) Int. Cl. H04L 9/08

(52) U.S. Cl. 380/278; 380/44

(57) ABSTRACT

In a storage system including a plurality of recording medium drives and encrypting and recording data with a device key, even if a recording medium drive fails and is replaced with another drive, the data stored by the failed recording medium drive can be reproduced. The plurality of recording medium drives has not only their own device keys, but also copies of the device keys of the other recording medium drives. If any one of the recording medium drives is replaced and data in a recording medium mounted in the replaced recording medium drive cannot be decrypted, the drive queries the other recording medium drives to acquire a copy of a device key of a recording medium drive used in the past and decrypts the encrypted data.

### INCORPORATION BY REFERENCE

This application relates to and claims priority from Japanese Patent Application No. 2010-066365 filed on Mar. 23, 2010, the entire disclosure of which is incorporated herein by reference.

### BACKGROUND OF THE INVENTION

(1) Field of the Invention

This invention relates to a storage system and a method for generating an encryption key in the storage system. In particular, this invention relates to a storage system capable of reproducing data from a recording medium even if a recording medium drive used to encrypt and store the data fails and is replaced with another recording medium drive, and a method for generating an encryption key in the storage system.

(2) Description of the Related Art

With the evolution in storage systems, some have been developed that include a plurality of recording medium drives used to record and reproduce data on a recording medium, such as an optical disc, for the purpose of performing sophisticated information processing. Such systems use a plurality of removable recording media, and therefore are sometimes referred to as “changer” or “library system”.

Japanese Patent Application Laid-Open No. 2005-31930 discloses a technique for improving response of a library system including a library accommodating a plurality of optical recording media, a cassette holding the plurality of optical recording media, and recording/reproducing drives.

### SUMMARY OF THE INVENTION

Many storage systems of the above-mentioned type perform data encryption with an encryption key before recording operations in order to improve the concealment of information. This encryption key is often a device key uniquely assigned to each recording medium drive of the storage system and prevents data on a recording medium from being reproduced by recording medium drives other than the recording medium drive used to record the data.

Alternatively, some storage systems control the plurality of recording medium drives so as to perform data reproduction only when all recording media at least necessary to process the information are mounted in the recording medium drives. In this case, authorization to reproduce the data is determined by retrieving a device key uniquely assigned to each of the mounted recording media.

In addition, some other storage systems encrypt and record data on a recording medium with an encryption key added with their own system IDs (a kind of device keys and hereinafter abbreviated to SysIDs in some instances) uniquely assigned to the respective storage systems. Even if a recording medium drive is detached from a storage system and attached to another storage system, this technique prevents the data that was recorded on the recording medium in the prior storage system from being reproduced in the latter storage system.

However, the following problem lies in the encryption and recording. In the case where data is encrypted and recorded with a device key uniquely assigned to each recording medium drive of the storage system as described above, if the recording medium drive used for recording fails and is replaced with another recording medium drive, the data recorded on the recording medium by the failed recording medium drive cannot be reproduced from the recording medium. So far, this problem has not been considered for even storage systems provided with a plurality of recording medium drives.

The present invention has been made in view of the above-described problem and provides a storage system capable of reproducing data from a recording medium even if a recording medium drive used to encrypt and store the data fails and is replaced with another recording medium drive, and a method for generating an encryption key in the storage system.

In order to solve the problem, an embodiment of the present invention is directed to a storage system, which includes a plurality of recording medium drives, having a storage controller that is connected to the plurality of recording medium drives and controls overall operations of the recording medium drives, a nonvolatile memory that stores a system ID unique to the storage system, and a plurality of recording medium drives. Each of the recording medium drives stores a drive ID unique to itself, is supplied with copies of drive IDs unique to the other recording medium drives via the storage controller, is supplied with a copy of the system ID stored in the nonvolatile memory via the storage controller, and encrypts and records data on a recording medium mounted therein and decrypts and reproduces the encrypted data based on the drive ID, the copies of the drive IDs and the copy of the system ID.

The embodiment of the present invention is also directed to a method for generating an encryption key for a storage system that includes a plurality of recording medium drives, the recording medium drives encrypting and recoding data on and reproducing and decrypting the encrypted data from recording media mounted in the recording medium drives with drive IDs unique to the recording medium drives and a copy of a system ID unique to the storage system. The method includes the steps of: (a) determining whether the plurality of recording medium drives include a newly-mounted recording medium drive; (b) if it is determined that a newly-mounted recording medium drive is present as a result of the determination in step (a), firstly instructing each of the recording medium drives to acquire copies of the drive IDs of the other recording medium drives; (c) determining whether the recording media are mounted in the recording medium drives; (d) if it is determined that the recording media are mounted in the recording medium drives as a result of the determination in step (c), determining whether a user has instructed the storage system to reproduce data recorded on the recording media; (e) if it is determined that the user has instructed the storage system to reproduce data stored in any of the recording media as a result of the determination in step (d), determining whether the recording medium drives associated with the recording media can decrypt the encrypted data reproduced from the recording media; and (f) if it is determined that the recording medium drives cannot decrypt the encrypted data reproduced from the recording media as a result of the determination in step (e), secondly instructing the recording medium drives to acquire copies of the drive IDs of the other recording medium drives. The copies of the drive IDs of the other recording medium drives, which are acquired in step (b), are added to generate an encryption key to encrypt the data. If it is determined that the recording medium drives cannot decrypt the encrypted data reproduced from the recording medium as a result of the determination in step (e), the copies of the drive IDs of the other recording medium drives, which are acquired in step (f), are added to generate an encryption key to decrypt the data.

The present invention can provide a data storage system capable of reproducing data from a recording medium even if a recording medium drive used to encrypt and store the data fails and is replaced with another recording medium drive, and a method for generating an encryption key in the storage system. In addition, the present invention has an effect of improving the operability of the storage system.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of the storage system according to an embodiment of the present invention.

FIG. 2A is an illustration of a method for generating an encryption key according to the embodiment of the present invention.

FIG. 2B is an illustration of another method for generating an encryption key according to the embodiment of the present invention.

FIG. 3 is a flow chart showing a method for generating an encryption key according to the embodiment of the present invention.

### DETAILED DESCRIPTION OF THE EMBODIMENT

An embodiment of the present invention will now be described with reference to the accompanying drawings.

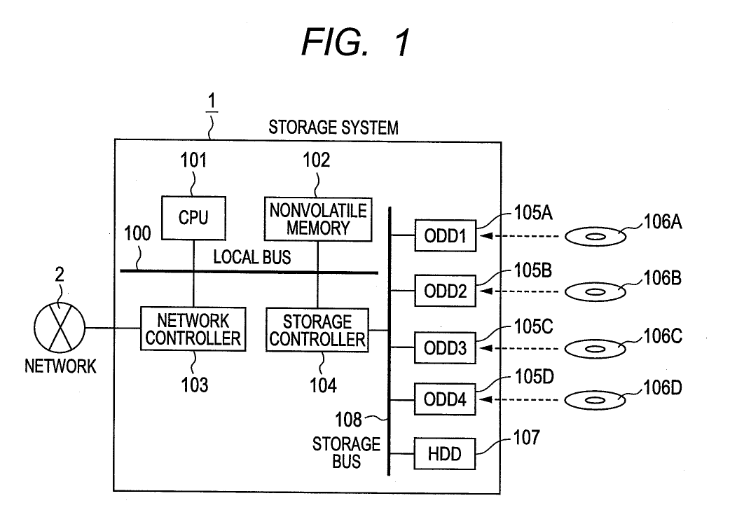

FIG. 1 is a block diagram of the storage system according to the embodiment of the present invention.

A storage system 1 includes a CPU (Central Processing Unit) 101 that controls operations of the entire storage system.

The CPU 101 controls a network controller 103 via a local bus 100 to receive data and programs supplied from other storage systems (not shown) connected with a network 2. The received data and programs are stored in, for example, a HDD (Hard Disk Drive) 107 via the network controller 103, the local bus 100, a nonvolatile memory 102, a storage controller 104, a storage bus 108.

Furthermore, the CPU 101 temporarily stores data, which is input by a user of the storage system 1 by using, for example, a mouse and keyboard (not shown), in the nonvolatile memory 102 and then stores the data in the HDD 107 under instructions from the user.

The data and programs stored in the HDD 107 are transferred to any one of or any plurality of ODDs (Optical Disc Drives) 1 to 4 (105A to 105D) according to the instruction of the CPU 101 given by the user. The transferred data and programs are encrypted in the ODDs (Optical Disc Drives) 1 to 4 (105A to 105D) and then stored on optical discs 1 to 4 (106A to 106D) mounted in the ODDs 1 to 4. After the data and programs are stored on the optical discs 1 to 4 (106A to 106D), the data and programs stored in the HDD 107 can be deleted as required. As is well known, the optical discs 1 to 4 (106A to 106D) can be removed from the storage system 1 and kept in storage.

Although this embodiment uses the four ODDs 105A to 106D, this number is, of course, not a prerequisite of the embodiment and any plural number of the ODDs can be used. Similarly, the storage system in this embodiment can use a plurality of HDDs 107, some of which do not need to be inside the storage system, but can be externally connected. The nonvolatile memory 102 can be also divided into a plurality of parts, some of which do not need to be in the storage system, but can be externally connected.

When the data and programs (hereinafter referred to as simply “data”) stored in the optical discs 1 to 4 (106A to 106D) are reproduced and processed, the CPU 101 provides instructions to the ODDs 1 to 4 (105A to 105D) to read out media keys specific to the mounted optical discs 1 to 4 (106A to 106D) and determine whether all optical discs necessary for processing are mounted. If the CPU 101 determines that all necessary optical discs are mounted as a result of the determination, the CPU 101 controls the storage controller 104 to start operations for data reproduction. Upon receipt of the instruction from the storage controller 104, the ODDs read out the encrypted, recorded data from the optical discs mounted therein to decrypt the data encrypted before recording, and supply the decrypted data to the storage controller 104.

Next, a description will be made about encryption for improving concealment, which is utilized, for example, to transfer and record data stored in the HDD 107 onto the optical discs 1 to 4 (106A to 106D) mounted in the ODDs 1 to 4 (105A to 105D). The encryption process is performed by the ODDs 1 to 4 (105A to 105D).

Typical encryption keys conventionally used for encrypted recording are often device keys uniquely assigned to respective recording devices. In reproduction of the data in the optical discs 1 to 4 (106A to 106D), the encryption keys are essential to decrypt the encrypted data. Therefore, users authorized to handle the data are limited, resulting in improved concealment.

One of the device keys is a first device key uniquely assigned to each ODD which records data onto an optical disc. For example, the device key given to an ODD 1 (105A) is referred to as ID 1, while the device key given to an ODD 2 (105B) is referred to as ID 2 (hereinafter the device keys given to other ODDs are referred to in a like manner). With the function of the first device key (ID 1, if recorded by the ODD 1), the data recorded on the optical disc cannot be reproduced by ODDs other than the ODD used to record.

Another device key is a second device key (SysID) uniquely assigned to the storage system 1. The second device key is stored in, for example, the nonvolatile memory 102. The SysID has been conventionally used as an encryption key. Specifically, the ODDs encrypt data to be recorded with two keys as encryption keys: the first device key of each ODD; and a copy of the second device key supplied from the storage system 1. Data recorded on an optical disc by an ODD cannot be reproduced by the ODD that is removed and attached to another storage system by the function of the second device key (SysID).

However, conventional techniques have not been developed with full attention to the case where a failed ODD is replaced. More specifically, since the first device key of a device is a device-specific key recognized by only that device, if the device develops irretrievable problems, all optical discs whose data is recorded at the device cannot be reproduced. This results in significant inconvenience for the user of the storage system 1.

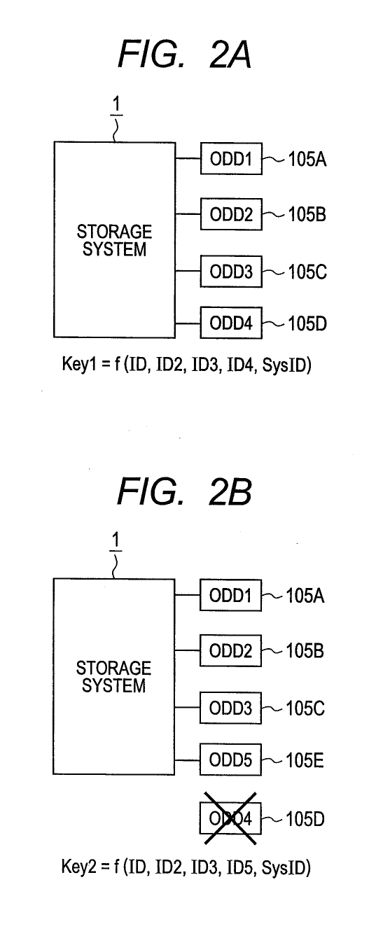

The embodiment of the present invention has been made to eliminate such an inconvenience. Specifically, in an exemplary storage system including a plurality of ODDs as shown FIG. 1, a copy of the first device key allocated to an ODD is given to the other ODDs. More specifically, each of the ODDs has copies of the other ODD's device keys in addition to its own device key and the device key copy of the storage system 1. Using the plurality of first device keys (ID1, ID2 . . . ) and the second device key (SysID) uniquely assigned to the storage system 1, the ODD encrypts data and records the encrypted data onto a predetermined optical disc. If any one of the ODDs fails and is replaced with a new ODD, the new ODD can obtain the copy of the first device key of the failed ODD from the other ODDs and decrypt the reproduced encrypted data. As long as the ODDs are in the same storage system 1 and each ODD operates on the same encryption algorithm, ODDs other than the failed and replaced ODD can decrypt the reproduced encrypted data. These issues will be further described with reference to FIGS. 2A and 2B.

FIG. 2A is an illustration of a method for generating an encryption key according to the embodiment of the present invention. FIG. 2A shows a method for generating an encryption key before an ODD's failure as described above. As an example, the storage system 1 is assumed to include ODDs 1 to 4 (105A to 105D). The respective ODDs are assigned with device keys ID1 to ID4 in this order, while the device key of the storage system 1 is SysID. Unlike the conventional techniques, each ODD in this embodiment obtains in advance copies of the first device keys owned by the other ODDs, and therefore, the ODDs mutually know the first device keys of the others. The ODDs generate an encryption key (Key 1) as represented by Function f with the first device keys ID1 to ID4 and the second device key SysID; the Function f is expressed by

Key1=f(ID1,ID2,ID3,ID4,SysID) (Expression 1)

The ODDs encrypt data in the aforementioned encryption manner with the encryption key and record the data onto their optical discs. Reproduction of the data can be made by decrypting the encrypted data using the Key 1.

Next, the case where an ODD fails and is replaced with an ODD 5 (105E) will be described.

FIG. 2B is an illustration of another method for generating an encryption key according to the embodiment of the present invention. Compared with FIG. 2A, the ODDs in FIG. 2B are different in that the ODD 4 (105D) is replaced with an ODD 5 (105E). The ODD 5 has a first device key ID5 that is different from any of ID1 to ID4. The other ODDs 1 to 3 (105A to 105C) still have the copy of the device key ID4 of the failed ODD 4 (105D) and are set not to delete the copy.

When each of the ODDs record new data on their optical discs, the ODDs generate an encryption key (Key 2) as represented by Function f with ID5 instead of ID4; the Function f is expressed by

Key2=f(ID1,ID2,ID3,ID5,SysID) (Expression 2)

The ODDs encrypt data in the aforementioned encryption manner with the encryption key (Key 2) and record the data on their optical discs. Reproduction of the data can be made by decrypting the encrypted data with Key 2.

However, the encrypted data that are recorded on optical discs by the failed ODD 4 (105D) cannot be decrypted with Key 2 in the new ODD 5 (105E). In order to solve the problem, when the ODD 5 determines that it cannot decrypt the data on an optical disc mounted therein, the ODD 5 queries any one of the other ODDs 1 to 3 (105A to 105C) to acquire a copy of the device key that was used in the past, but not at present. With the acquisition of the ID4 copy, the ODD 5 (105E) can decrypt the reproduced encrypted data. In the case where frequent ODD replacement due to failures has been done, the ODD 5 (105E) needs to acquire copies of a plurality of device keys used in the past and tries decryption with the acquired device keys one by one until the encrypted data is properly decrypted. After finding the device key that allows the ODD 5 (105E) to perform proper decryption, the ODD 5 (105E) continues reproducing operations of the data with the device key. For the case where none of the device keys can be used to properly perform decryption, it may be possible to design the storage system to alert decryption failure.

Each ODD, which was queried by the other ODDs about the device key used in the past, can provide a copy of the device key used in the past; however, the ODD can also provide a copy of an encryption key (e.g., the Key 1) used in the past if the encryption algorithm of the ODD is compatible with that of the others.

Next, a method for generating an encryption key in the storage system according to the embodiment will be described.

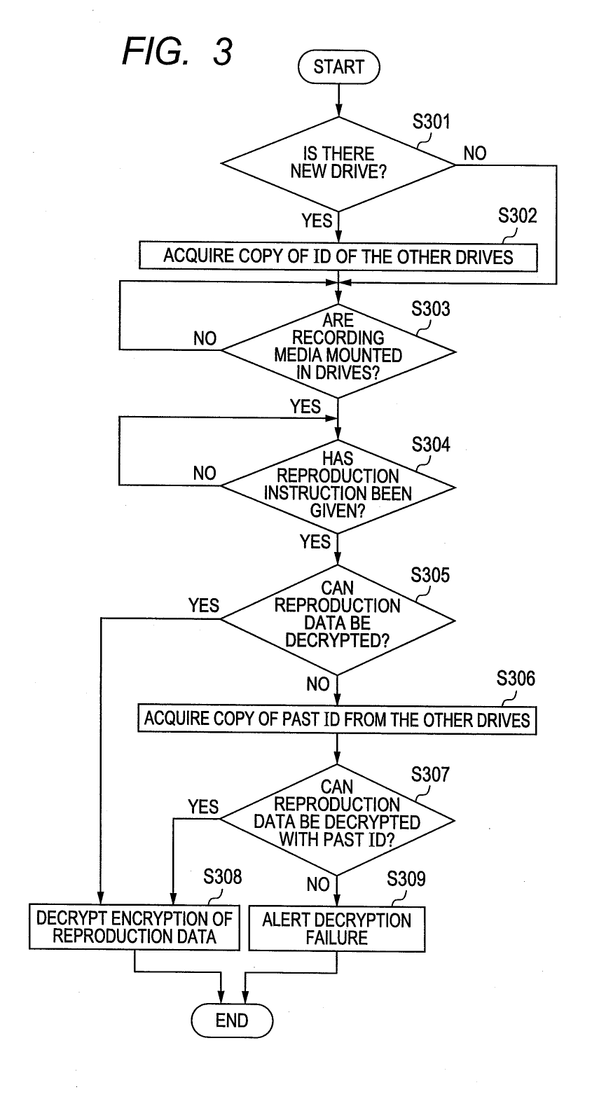

FIG. 3 is a flow chart showing the method for generating an encryption key according to the embodiment of the present invention. In the following description, all of the ODDs, which are recording medium drives mounted in the storage system 1, may be collectively referred to as ODDs 105 or drives 105. Similarly, all of the optical discs, which are recording media mounted in the ODDs 105, may be collectively referred to as optical discs 106.

Once the storage system 1 is started, the storage controller 104 queries a plurality of ODDs 105 about their device keys under the instruction from the CPU 101 at step S301, and determines whether a newly-mounted drive (e.g., 105E in FIG. 2B) is present or not. If the storage controller 104 determines that a new drive is connected as a result of the determination (“Yes” in FIG. 3), the new drive acquires copies of IDs, which are device keys, from the other drives and storage system 1, while the other drives acquire a copy of an ID, which is the device key of the new drive, under the instruction from the storage controller 104 at step S302. Needless to say, drives in a storage system that is started for the first time are all new, and therefore all the drives obtain copies of IDs or device keys of the other drives and storage system 1. Although it is not shown in the flow chart in FIG. 3, encryption of data is performed with an encryption key generated with the IDs or device keys of all the drives 105 and storage system 1, and then the encrypted data is recorded by predetermined drives onto predetermined recording media.

The following is a description about a method for generating an encryption key mainly relevant to decryption of reproduction encrypted data at the time of reproducing the data.

After acquiring predetermined IDs at step S302 or after determining that a new drive is not connected (“No” in FIG. 3) at previous step S301, the storage controller 104 determines whether the recording media 106 are mounted in the drives 105 at step S303. For a single process using data reproduced from a plurality of recording media, media keys, which are read out from the recording media mounted in the storage system, can be used to determine whether all of the necessary recording media are mounted.

As a result of the determination at step S303, if the storage controller 104 determines that the recording media 106 are not mounted in the respective drives 105 (“No” in FIG. 3), the storage controller 104 repeats the same process in step S303 until the result of the determination at step S303 changes. If the storage controller 104 determines that the recording media 106 are mounted in the respective drives 105 (“Yes” in FIG. 3), the CPU 101 determines whether a user has provided an instruction to reproduce data of the recording media 106 at step S304.

As a result of the determination at step S304, if the CPU 101 determines that the user has not provided the instruction (“No” in FIG. 3), the CPU 101 repeats the same process in step S304 until the result of the determination made at step S304 changes. It is not shown in FIG. 3; however, if any other instruction except for reproduction is made, operations in accordance with the instruction, for example recording operations, will be performed. If the CPU 101 determines that the user has made an instruction to reproduce data stored in any of the recording media 106 (“Yes” in FIG. 3), the storage controller 104 instructs the drive containing the data designated by the user to read out the data at step S305. The drive determines whether it can decrypt the read data, which was encrypted at the time of recording.

As a result of the determination at step S305, if the drive determines that the drive cannot decrypt the reproduction data that was encrypted by the drive at the time of recording and designated by the user to reproduce (“No” in FIG. 3), the drive with the data stored acquires an ID, namely an device key of the drive mounted in the past, from the other drives under the instruction of the storage controller 104 at step S306. Subsequently, at step S307, the drive with the data stored determines whether the data can be decrypted with the ID acquired at step S306. In the case of having acquired a plurality of IDs, the IDs are tried out one by one until an ID available to decrypt is discovered.

As a result of the determination at step S307, if the drive with the data stored determines that any IDs acquired at step S306 cannot decrypt the encrypted data (“No” in FIG. 3), the CPU 101 alerts the user that decryption of the encrypted data is unfeasible at step S309 and terminates the flow.

As a result of the determination at step S307, if the drive with the data stored determines that one of the IDs acquired at step S306 can decrypt the encrypted data (“Yes” in FIG. 3) or if the drive determines at step S305 that the drive can decrypt the reproduction data, which was encrypted by the drive at the time of recording and designated by the user to reproduce (“Yes” in FIG. 3), the drive decrypts the reproduction data with the given ID at step S308 and terminates the flow.

The aforementioned embodiment is merely an example and is not to be limitative of the scope of the present invention. Although optical discs are used as an example of removable recording media, even an HDD and an IC card using semiconductor memory are also applicable to the embodiment. In addition, the steps that are performed by the CPU 101 in FIG. 3 can be executed by the storage controller 104. Various other different embodiments along the spirit of the present invention are conceivable and those are all within the scope of the present invention.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A storage system including a plurality of recording medium drives comprising:
a storage controller that is connected to the plurality of recording medium drives and controls overall operations of the recording medium drives;
a nonvolatile memory that stores a system ID unique to the storage system; and
a plurality of recording medium drives, each of which stores a drive ID unique to itself, is supplied with copies of drive IDs unique to the other recording medium drives via the storage controller, is supplied with a copy of the system ID stored in the nonvolatile memory via the storage controller, and encrypts and records data on a recording medium mounted therein and decrypts and reproduces the encrypted data based on the drive ID, the copies of the drive IDs and the copy of the system ID.

2. The storage system according to claim 1, wherein when the recording medium drive cannot decrypt the encrypted data reproduced from the recording medium with the drive ID, the copies of the drive IDs and the copy of the system ID, the storage controller acquires copies of the drive IDs unique to the other recording medium drives again from the other recording medium drives to supply the copies to the recording medium drive.

3. The storage system according to claim 1, wherein the recording medium is an optical disc and the recording medium drive is an optical disc drive.

4. A method for generating an encryption key for a storage system that includes a plurality of recording medium drives, the recording medium drives encrypting and recoding data on and reproducing and decrypting the encrypted data from recording media mounted in the recording medium drives with drive IDs unique to the recording medium drives and a copy of a system ID unique to the storage system, the method comprising:
a recording medium drive determination step of determining whether the plurality of recording medium drives include a newly-mounted recording medium drive;
a first drive-ID acquisition step of, if it is determined that a newly-mounted recording medium drive is present as a result of the determination in the recording medium drive determination step, instructing each of the recording medium drives to acquire copies of the drive IDs of the other recording medium drives;
a recording-media presence determination step of determining whether the recording media are mounted in the recording medium drives;
a reproduction instruction determination step of, if it is determined that the recording media are mounted in the recording medium drives as a result of the determination in the recording-media presence determination step, determining whether a user instructs the storage system to reproduce data recorded on the recording media;
a decryption feasibility determination step of, if it is determined that the user has instructed the storage system to reproduce data stored in one of the recording media as a result of the determination in the reproduction instruction determination step, determining whether the recording medium drive related to the recording medium can decrypt the encrypted data reproduced from the recording media; and
a second drive-ID acquisition step of, if it is determined that the recording medium drives cannot decrypt the encrypted data reproduced from the recording medium as a result of the determination in the decryption feasibility determination step, instructing the recording medium drive to acquire copies of the drive IDs of the other recording medium drives, wherein
the copies of the drive IDs of the other recording medium drives, which are acquired in the step of firstly instructing the recording medium drives to acquire copies of the drive IDs of the other recording medium drives, are added to generate an encryption key to encrypt the data, and
if it is determined that the recording medium drive cannot decrypt the encrypted data reproduced from the recording medium as a result of the determination in the decryption feasibility determination step, the copies of the drive IDs of the other recording medium drives, which are acquired in the second drive-ID acquisition step, are added to generate an encryption key to decrypt the data.
